(19) United States
(12) Patent Application Publication
(10) Pub. No.: US 2011/0282647 A1
(43) Pub. Date: Nov. 17, 2011

(54) Translation System and Method

(75) Inventor: Valerio Pastore, Milano (IT)

(73) Assignee: IQTRANSLATE.COM S.r.l., Milano (IT)

(21) Appl. No.: 12/778,262

(22) Filed: May 12, 2010

(51) Int. Cl. G06F 17/28

(52) U.S. Cl. 704/4; 704/7; 704/E11.001

(57) ABSTRACT

A system for translating text from a source language to a target language comprising a user client program component running over a local PC of a user, from which a translation request is sent; a server program component running over a server workstation; and a translator client program running over a local PC of a translator, from which a translation request is processed.

### BACKGROUND OF THE INVENTION

The present invention relates to an internet based translation system and method that provides a high quality text translation in a relatively short time.

At the present time a text translation of a document from a source language to a target text language can be made by means of an automatic translator, sometimes referred to as a “machine translation,” or by sending the source text to a professional translator agency, sometimes called a “custom translation” or “manual translation”.

Usually, the automatic translators provide a very fast translation, but the work product is generally replete with mistakes, due to the fact that the automatic software is not able to recognize the specific context in which a text to be translated is written, or due to other faults or limitations of an automatic translator. This usually means that the output translation needs to be revised by the requester to manually modify some words or some phrases, resulting in unwanted additional work and consequently in a time loss.

Using a professional translator agency provides an accurate translation, but at a disadvantage that the translation is not provided quickly.

### SUMMARY OF THE INVENTION

The invention provides a translator that provides translations generally as quickly as an automatic translation, and also generally as correctly as a translator agency. Also, the invention aims at providing a translation fitted with the specific language of the particular field which the source text belongs to.

In one form, the system and method according to the invention is constituted of three fundamental parts:
a user client component running over the local PC of a user, from which a translation request is sent;
a server component running over a server workstation; and
a translator client component running over the local PC of a translator, from which a translation request is processed.

The invention provides a system for translating text from a source language to a target language comprising: a computer system having an operation program for receiving a translation request from a user and for implementing a translation, said computer being connected to the internet, said program obtaining at least two complete translations of a source language to a target language using at least two different respective machine translation programs, said operation program rating the accuracy of each complete translations by searching for a string of words of the target language translation in an internet search engine for each translation program, and selecting as the final automatic machine translation the complete translation from the translation program having the highest number of matches from the search engine for the word string.

The present invention provides an article of manufacture comprising a computer usable medium having computer readable program code embodied therein for causing a translation of text from a source language to a target language, the computer readable program code in said article of manufacture comprising: computer readable program code for receiving a translation request from a user and for implementing a translation, said program obtaining at least two complete translations of a source language to a target language using at least two different respective machine translation programs, said program code obtaining a rating of the accuracy of each complete translation by searching for a string of words of the target language translation in an internet search engine for each translation program, and selecting as the final automatic machine translation the complete translation from the translation program having the highest number of matches from the search engine for the word string.

The present invention provides a method for translating text from source language to a target language, comprising: receiving a translation request from a user and for implementing a translation; obtaining at least two complete translations of a source language to a target language using at least two different respective machine translation programs; rating the accuracy of each complete translation by searching for a string of words of the target language translation in an internet search engine for each translation program; and selecting as the final automatic machine translation, the complete translation from the translation program having the highest number of matches from the search engine for the word string.

The method may include obtaining complete translations using automatic machine translations on a pre-selected list of automatic machine translations. The strings of words may be consecutive strings of words. The strings of words may be are consecutive strings of words starting with the first word. The step of rating may comprise rating the translation programs by searching for a plurality of strings of words of increasing length. The method may further comprise providing the final automatic machine translation to a selected human translator for review according to selection criteria. The selection criteria may include knowledge of the source and target languages, and the subject matter field of the text of the human translations. The selection criteria may include rating information for each human translator. The selection criteria may include human-time needed for a human translator to review and execute further translation processing. The selection criteria may include information on the workload of each human translator. The operation program may control storage of information rating the junior translators based on reviews by senior translators. The method may comprise controlling storage of information of a user's account. The method may comprise using a personal computer (PC) and a server computer. The method may comprise providing a user with selection of a first quick translation mode of a certain number of words within a first time period, and a second, longer translation mode of a greater number of words within a longer time period. The method may comprise controlling storage of translations in an archive.

The invention provides a system for translating text from a source language to a target language comprising: a user client program component running over a local PC of a user, from which a translation request is sent; a server program component running over a server workstation; and a translator client program running over a local PC of a translator, from which a translation request is processed.

### BRIEF DESCRIPTION OF THE DRAWINGS

FIG. 1 is a block diagram showing a user PC workstation connected to the internet and having access to specific translations available of the internet;

FIG. 2 is a block diagram similar to FIG. 1, showing connection of a user PC workstation to send a translation request to the first automatic translation of an available preset list of specific translations;

FIG. 3 is a block diagram similar to FIG. 1, showing a translated text sent from the first automatic translator to the user PC workstation;

FIG. 4 is a block diagram showing a user PC workstation connected to the internet to an internet search engine, such as Google;

FIG. 5 is a block diagram similar to FIG. 4, showing a number of search result matches for a particular search term of a certain length;

FIG. 6 is a block diagram showing a user PC workstation connected over the internet;

FIG. 7 is a block diagram showing a user PC workstation connected over the internet to a search engine;

FIG. 8 is a block diagram showing a user PC workstation connected to the internet to a search engine which has selected the best automatic translation using a search criteria;

FIG. 9 is a screenshot of a menu graphic user interface (GUI) for a junior human translator; and

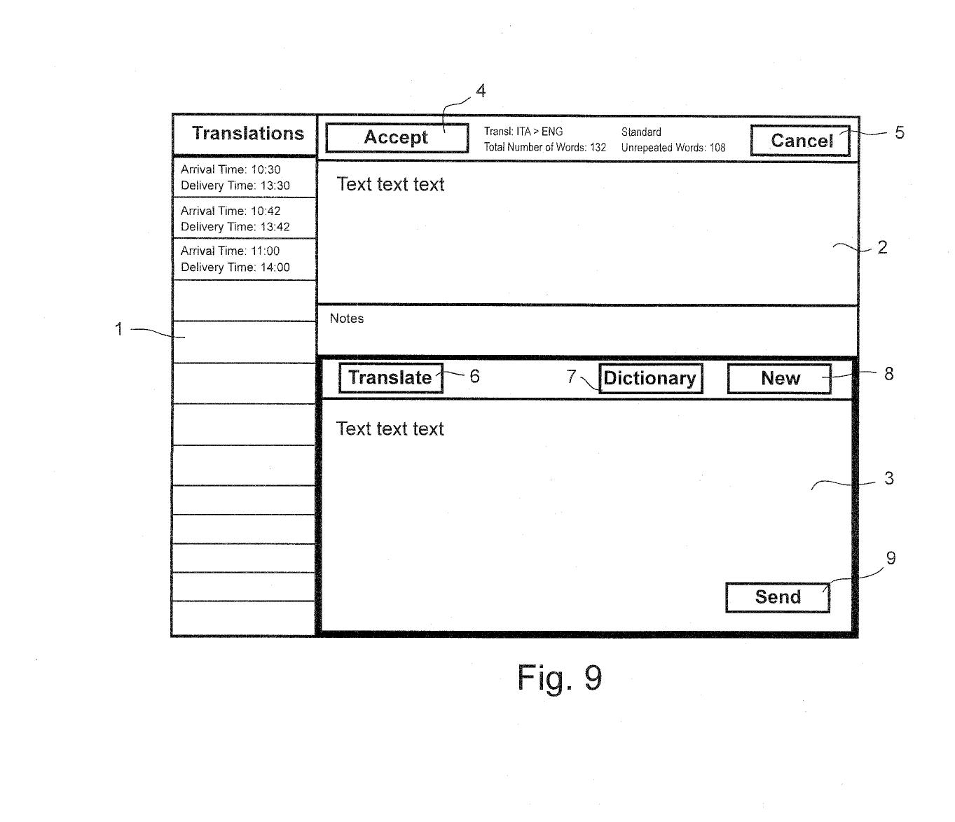

FIG. 10 is a screenshot of a menu graphic user interface (GUI) for a senior human translator.

### DETAILED DESCRIPTION OF THE PREFERRED EMBODIMENT

The invention provides a system for translating text from a source language to a target language comprising: a computer system having an operation program for receiving a translation request from a user and for implementing a translation, said computer being connected to the internet, said program obtaining at least two complete translations of a source language to a target language using at least two different respective machine translation programs, said operation program rating the accuracy of each complete translations by searching for a string of words of the target language translation in an internet search engine for each translation program, and selecting as the final automatic machine translation the complete translation from the translation program having the highest number of matches from the search engine for the word string.

The operation program may obtain a complete translation using automatic machine translations on a pre-selected list of automatic machine translations. The string of words may be a string of consecutive words. The string of words may be a string of consecutive strings of words starting with the first word in the same language text. The operation program may rate the translation programs by searching for a plurality of strings of words of increasing length. The operation program may provide the final automatic machine translation to a selected human translator for review according to selection criteria. The selection criteria may include knowledge of the source and target languages, and the subject matter field of the text of the human translators. The selection criteria may include rating information for each human translator. The selection criteria may include human-time needed for a human translator to review and execute further translation processing. The operation program may control storage of information for human translators in a first group of senior translators, and a second group of junior translators. The operation program may control storage of information rating the junior translators based on reviews by senior translators. The operation program may control storage of information of a user's account. The computer system may comprise a user personal computer (PC) and a server computer. The operation program may provide a user with selection of a first quick translation mode of a certain number of words within a first time period, and a second, longer translation mode of a greater number of words within a longer time period. The operation program may control storage of translations in an archive.

The present invention provides an article of manufacture comprising a computer usable medium having computer readable program code embodied therein for causing a translation of text from a source language to a target language, the computer readable program code in said article of manufacture comprising: computer readable program code for receiving a translation request from a user and for implementing a translation, said program obtaining at least two complete translations of a source language to a target language using at least two different respective machine translation programs, said program code obtaining a rating of the accuracy of each complete translation by searching for a string of words of the target language translation in an internet search engine for each translation program, and selecting as the final automatic machine translation the complete translation from the translation program having the highest number of matches from the search engine for the word string.

The program code may obtain a complete translation using automatic machine translations on a pre-selected list of automatic machine translators. The strings of words may be consecutive strings of words. The strings of words may be consecutive strings of words starting with the first word. The program may recite the translation programs by searching for a plurality of strings of words of increasing length. The program may provide the final automatic machine translation to a selected human translator for review according to selection criteria. The selection criteria may include knowledge of the source and target languages, and the subject matter field of the text of the human translators. The selection criteria may include rating information for each human translator. The selection criteria may include human-time needed for a human translator to review and execute further translation processing. The selection criteria may include information on the workload of each human translator. The operation program may control storage of information for human translators in a first group of senior translators, and a second group of junior translators. The program may control storage of information rating the junior translators based on reviews by senior translators. The program may control storage of information of a user's account. The program may provide a user with selection of a first quick translation mode of a certain number of words within a first time period, and a second, longer translation mode of a greater number of words within a longer time period. The program may control storage of translations in an archive.

The present invention provides a method for translating text from source language to a target language, comprising: receiving a translation request from a user and for implementing a translation; obtaining at least two complete translations of a source language to a target language using at least two different respective machine translation programs; rating the accuracy of each complete translation by searching for a string of words of the target language translation in an internet search engine for each translation program; and selecting as the final automatic machine translation, the complete translation from the translation program having the highest number of matches from the search engine for the word string.

The method may include obtaining complete translations using automatic machine translations on a pre-selected list of automatic machine translations. The strings of words may be consecutive strings of words. The strings of words may be are consecutive strings of words starting with the first word. The step of rating may comprise rating the translation programs by searching for a plurality of strings of words of increasing length. The method may further comprise providing the final automatic machine translation to a selected human translator for review according to selection criteria. The selection criteria may include knowledge of the source and target languages, and the subject matter field of the text of the human translations. The selection criteria may include rating information for each human translator. The selection criteria may include human-time needed for a human translator to review and execute further translation processing. The selection criteria may include information on the workload of each human translator. The operation program may control storage of information rating the junior translators based on reviews by senior translators. The method may comprise controlling storage of information of a user's account. The method may comprise using a personal computer (PC) and a server computer. The method may comprise providing a user with selection of a first quick translation mode of a certain number of words within a first time period, and a second, longer translation mode of a greater number of words within a longer time period. The method may comprise controlling storage of translations in an archive.

The invention provides a system for translating text from a source language to a target language comprising: a user client program component running over a local PC of a user, from which a translation request is sent; a server program component running over a server workstation; and a translator client program running over a local PC of a translator, from which a translation request is processed.

A detailed description of a preferred embodiment will be described, but the present invention is not limited to this embodiment.

These three main components of a translation system according to a preferred embodiment of the invention are a user client component, a server component and a translator client component. These components will be described in more detail below.

The user client component comprises a software program that can be downloaded and started on the local PC by a user who has registered on a web portal through the completion of an application form. The preferred solution for the translation payment foresees a phase in which the registered user can buy credits by using his own credit card. In particular, these credits correspond (or are otherwise related) to the number of words that can be translated by using the quoted tool. As the user client component starts, a graphical user interface (GUI) appears. The user then provides the login data and then the authentication process runs by means of the exchange data with the server component.

After the authentication succeeds, the user visualizes his workspace. This workspace allows the user to input new requests for translation and look for/edit previously archived translation requests (depending on their status the requests can be edited and modified).

In case of input of new translation requests, the user first chooses between two different translation modes: Quick-Translation or Standard-Translation. The Quick-Translation mode provides a translation of a text of a certain number of words in a certain time period, such as, for example, 125 words within 3 hours. In comparison, the Standard-Translation mode provides a translation of a text of a larger quantity of words than the Quick-Translation mode, and with a slower turn around time, for example, of 250 words within 24 hours.

After a user makes this choice, the user specifies certain parameters, such as:
the source text language;
the target language;
the field which the source text belongs to (e.g. scientific, legal, fashion, etc.); and
possibly the “token application”.

The “token application” is useful in case of a text exceeding the admitted maximum words number. In this case, the user can buy or spend a previously bought token that allows to double the maximum number of words that can be translated in each of the two work modes, Quick and Standard.

After the cited selections are made by the user, the user can write down the text to be translated in a window of the workspace and can put also some notes for the translator in a separate window of the same workspace. The user can save the written text on a local PC (local archive) or on the server (workstation) by clicking on the save button.

If a token application has been used, but the source text does not exceed the maximum number of words that can be translated in the specific selected mode, a popup window alerts that the token has been automatically unmarked. Moreover, the used credits are calculated by counting each repeated word just one time. When the text is ready to be translated the user clicks the send button to save the text and send it to the server component.

In case of search and/or editing of previous translation requests, each request can be found into the workstation (server component) with a status flag, e.g. pending, released, working, canceled etc. The archive/workstation contains also the source texts to be translated.

The user can query the translation archive to check the status of a translation or to re-read a previous translation. Also, the user can cancel or edit a request for a translation until its status is in pending, meaning that the processing of a request has not yet started.

The system alerts with a popup window if there are unread delivered/available translations. Finally, a search engine has been implemented which allows to search a word or a group of words into the archived translations or the translated texts.

The server component will now be described. When the server component receives a translation request, sent through the client component, two parallel processes start:
1. a process to select the most accurate automatic translator for providing a preliminary automatic translation of the source text; and
2. a process to select the most appropriate “human” translator which will review the preliminary automatic translation thereby delivering, in relatively short time, a final high quality translation.

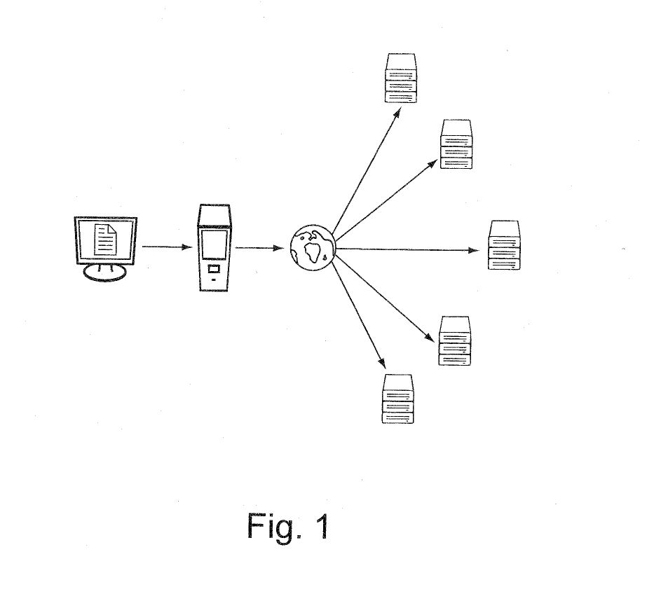

In the first of the above parallel processes (the selection of the automatic translator), the server component starts the so-called translation engine application that is in charge of providing an automatic translated text. The translation engine establishes a connection with a preset list of automatic field specific translators available on the internet as it is shown in FIG. 1.

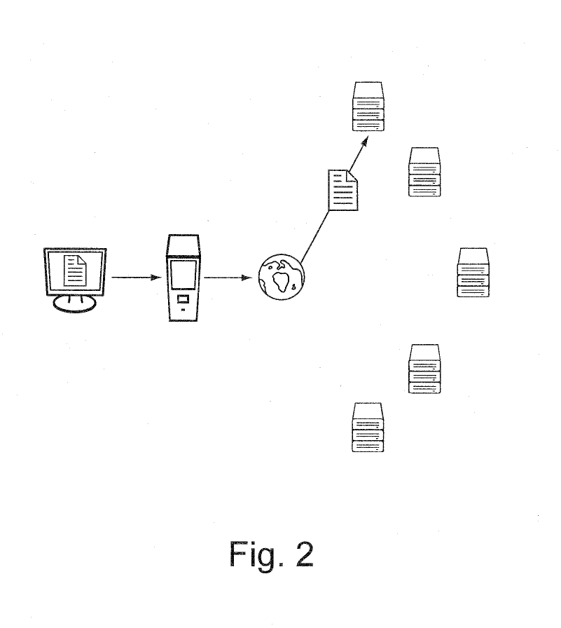

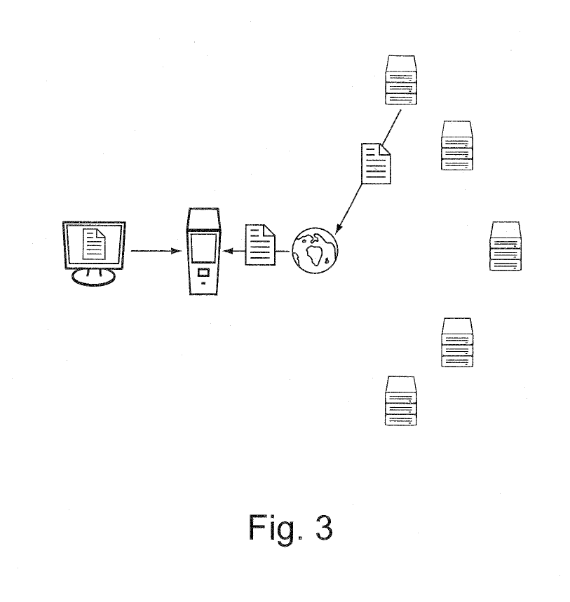

Once the connection has been established, the translation engine sends the received translation request to a first automatic translator of the preset list (see FIG. 2) and waits for the corresponding translated text. Once the translated text is received the software saves it on the workstation (see FIG. 3).

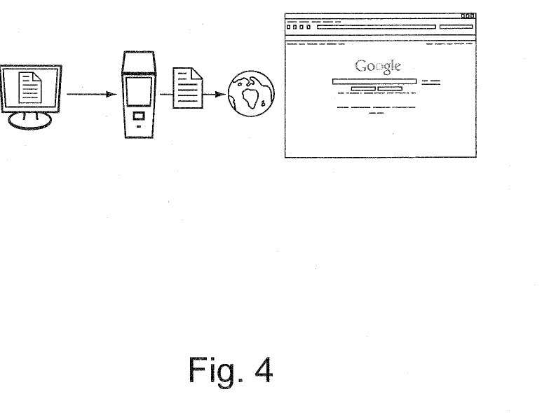

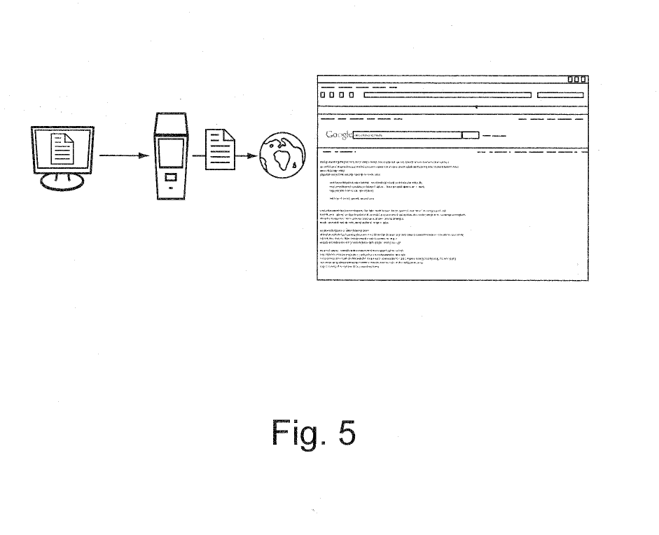

These steps are repeated for each automatic translator of the preset list so as to collect a translated text for each automatic translator. Subsequently, the translation engine connects with an internet search engine, e.g., Google as shown in FIG. 4, and begins a rating of each automatic translator through an evaluation of the respective translated text according to a recursive algorithm (see FIG. 5).

In particular, the recursive algorithm takes the first provided word of the translated text and looks for it on the internet by means of the search engine, obtaining a first number of matches. Afterward, it takes the group of the first two words of the translated text and looks for an expression made of the two words on the internet, obtaining a second number of matches (like the search in Google of two words between quotation marks). Then, it takes the group of the first three translated words and so on until the whole text has been taken or no matches at all are found.

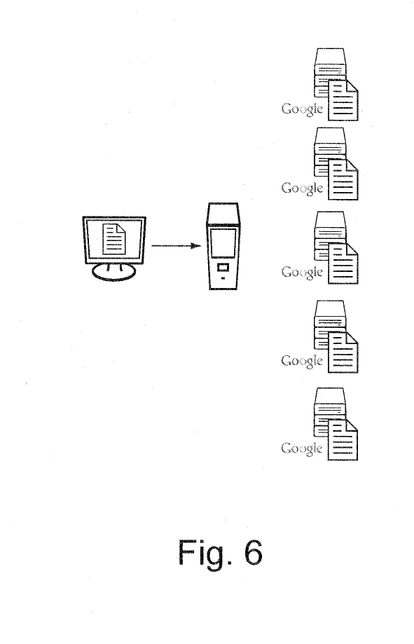

The series of number of matches, obtained in this way, is saved by the translation engine (see FIG. 6). The rating steps are repeated for each automatic translator of the preset list.

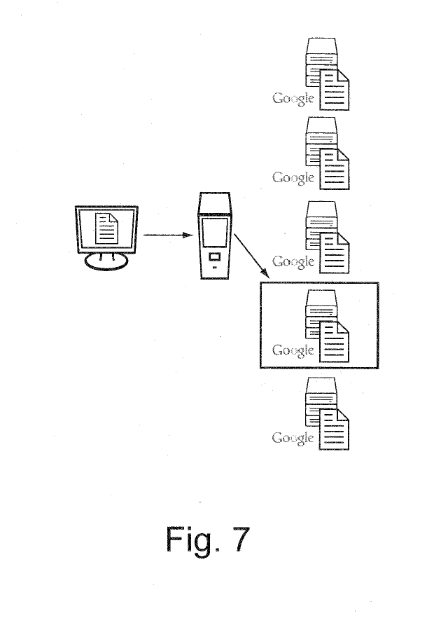

At the end of this process the translator engine selects the automatic translator which has performed the highest accuracy rate, being the accuracy rate directly proportional to the number of matches of the translated words grouped by means of the above described algorithm (see FIG. 7).

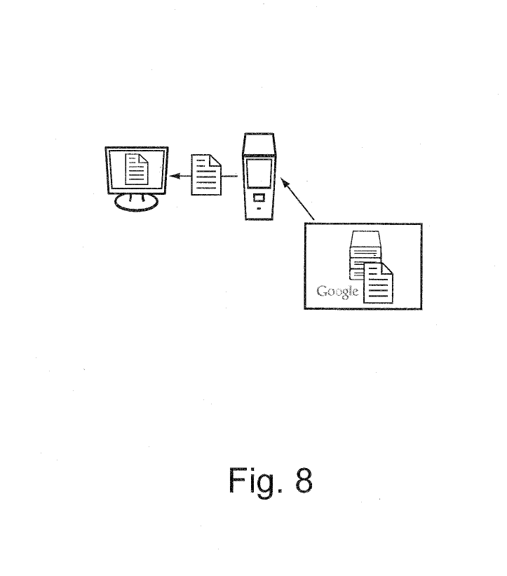

Finally, the translator engine identifies the text given by the selected automatic translator to be the most accurate (“best automatic translation”) and offers it as output of the automatic translation procedure (see FIG. 8).

Once this process has been completed, the server component sends the text to be translated and the corresponding “best” automatic translation to a “human” translator.

The selection of the “human” translator is based on parameters, specific for each “human” translator, that are managed by the server component by means of profiles saved on the workstation. Two types of “human” translators are used by the server component. One type is more experienced than the other type. The two types will be referred to herein as senior and junior. Of course, more than two types can be used.

A junior translator is a basis level translator who needs the supervision of an expert or more senior translator. A senior translator is an expert who does not need any supervision and whose translations do not need any review. A senior translator is also responsible for the junior translator's reviews.

Each “human” translator has a profile saved on the server workstation that contains all the parameters necessary for the translation request assignments. In particular, besides the personal data and the translator type (junior/senior), each profile for that translator comprises:
the known languages;
the translation languages (origin or source language->target language);
the known text or subject matter fields (e.g. scientific, business, legal, fashion, etc.);
the working time;
the mean time needed for the execution of a Standard translation (automatically updated after each completed translation);
the mean time needed for the execution of a Quick translation (automatically updated after each completed translation); and
a translator rating (only for junior translators, obtained as explained below).

Each “human” translator has a specific competence in one or more translation languages, such as from English to Italian or from French to Italian, etc., and in one or more text or subject matter fields, such as legal, business, scientific, fashion, etc.

Each junior translator is characterized by a rating that is updated after each translation, after review by a reviewing senior translator. When a translation request is assigned to a junior translator, he sends the translated text to a senior translator for a final check.

If a junior translator receives a negative evaluation by a senior translator, he can read the corresponding evaluation or opinion that the senior translator reports, so that he can learn what area(s) could be improved. In ease of a positive evaluation the senior translator can choose whether to write down the corresponding opinion or not.

In any case of a negative or positive review, when the senior translator terminates his review or check, he sends back the translation to the server component which stores it on the workstation and makes it available to the user.

Once a translator request is received, the server component chooses the “human” translator which to assign the request, following predefined choice or selection criteria. The server component first looks for the available “human” translators by means of the working time parameter saved in each translator profile. Among the available translators, the server component identifies the translators having the translation competence that fits with the request thereby considering the source text language, the target language and the particular field which the source text belongs to (data inputted by the user when inserting a translation request). Among the available and competent translators, the server component then selects the translator who has the highest rating.

If there are two or more available translators with the same rating, the server component selects the translator who has the lowest execution mean time. In case of equal execution mean time, the server component selects the translator who has the smallest workload. To a parity of workload, the server component selects the translator who has the highest time availability in the near future. For example, among two translators, the server component selects the translator who works from 9.00 a.m. to 6.00 p.m. instead of the translator who works from 3.00 p.m. to 6.00 p.m.

To a parity of all the described choice criteria, the translation request is sent to all the available and competent translators, and the translator who first accepts the request is assigned the translation.

During the assignment process the server component does not take into account the translator type (junior or senior).

Once the request is assigned, the selected translator has the option to refuse it. In this case, if the translator who refuses the request is a junior translator, the translator will receive a negative evaluation. The assignment process will then restart by eliminating the translator who refused the assignment.

Once the best automatic translation is identified, it is provided to the “human” translator to whom the translation job has been assigned and who has accepted the job, in order for him/her to quickly review the automatic translation based on his/her linguistic and field specific competence, thereby delivering in short time a final high quality translation.

At the end of the translation process, the server component archives on the workstation the completed translation requests comprising the following plurality of data:
the arrival time of the request;
the user name;
the estimated delivery time;
the number of words of the source text;
the number of unrepeated words of the source text;
the source language;
the target language;
the text field;
the user notes;
the time when the translator has accepted the request;
the translated text provided by a junior translator;
the reviewed translated text;
the senior translator notes; and
the translation request status.

It is thus possible to perform searches among the stored translation requests based on the above data.

However, just some of the above data are made available to the user who requested the translation. For example, the translated text provided by a junior translator and the senior translator notes are not accessible by the user.

At the end of the archiving step, a purchase invoice is generated, archived and sent to the user by e-mail. In particular, if the payment is done by using a credit card, the server component generates the purchase invoice when the payment terminates successfully. If the payment is done by means of a bank transfer the server component waits for the termination of the transactions and finally generates the purchase invoice.

The translator client component will now be described. Each “human” translator is provided with a software application directly connected to the workstation, through which it is possible to perform the translation processing. When this application is started the translator provides the login data and after a succeeded authentication, a graphic user interface (GUI) appears. The functionalities available on the GUI are different depending on the translator type (junior or senior).

As shown in FIG. 8, the GUI for the translation processing available to the junior translator comprises a first area showing the list of the incoming translation requests 1, a second area for the visualization of the text to be translated 2 and a third area in which the translated text can be edited 3.

In the first area 1, the translation requests assigned to the translator are listed. For each request, the time when it has been assigned and the estimated time for delivering the translation are shown. In the second area 2, the source text corresponding to the currently selected translation request is shown. Moreover, in the said second area the source language, the target language, the field which the text belongs to, the chosen translation modes (Quick or Standard), the total number of words contained in the source text, the number of unrepeated words of the said source text and the notes written by the user are indicated.

In the second area 2 two buttons are also present, an Accept button 4 and a Cancel button 5. The Accept button 4 allows the translator to accept the translation request. When this Accept button 4 is pushed, the time count starts and the status of the request changes from “pending” to “working”.

If the connected translator does not accept the translation request before a fixed amount of time, the assignment process restarts leaving out the “inactive” translator.

If, after the reassignment, the “inactive” translator clicks on the Accept button 4 to accept the translation request, a pop-up window appears to inform the translator that the request has been reassigned to another translator and that he has received a negative evaluation.

In case a translation request appearing in the list of two or more translators is accepted by one of them, a window pops-up to the other translators in order to inform them about the assignment of the request, as soon as they push the Accept button 4 to accept the request.

The Cancel button 5 present in the second area 2 allows the translator to refuse the request. By clicking on it, a pop-up window appears in order to allow the translator to confirm the refusal by choosing one of two or more possible reasons offered by the system, examples being: “insulting matter” or “text too demanding”. If a translator chooses “text too demanding”, the translator receives a negative evaluation.

The third area 3 can be filled-in with the translated text. It is, thus, editable only if the translator accepts the translation request. In this area there are four buttons, Translate button 6, Dictionary button 7, New button 8, Send Button 9. By clicking on the Translate button 6 the best automatic translation provided by the translation engines (selected as described above) appears in the third area 3 and can be edited by the translator.

The Dictionary button 7 allows the translator to visualize a list of words belonging to the field of the text and their corresponding translation. By clicking on the New button 8 the translator can add one word to the above cited list. Finally the Send button 9 allows the translator to complete the translation. The time counter then stops and the translation is then sent to a senior translator for the final cheek. Also, a dialog window opens up in which the translator can write down some notes for the senior reviewer.

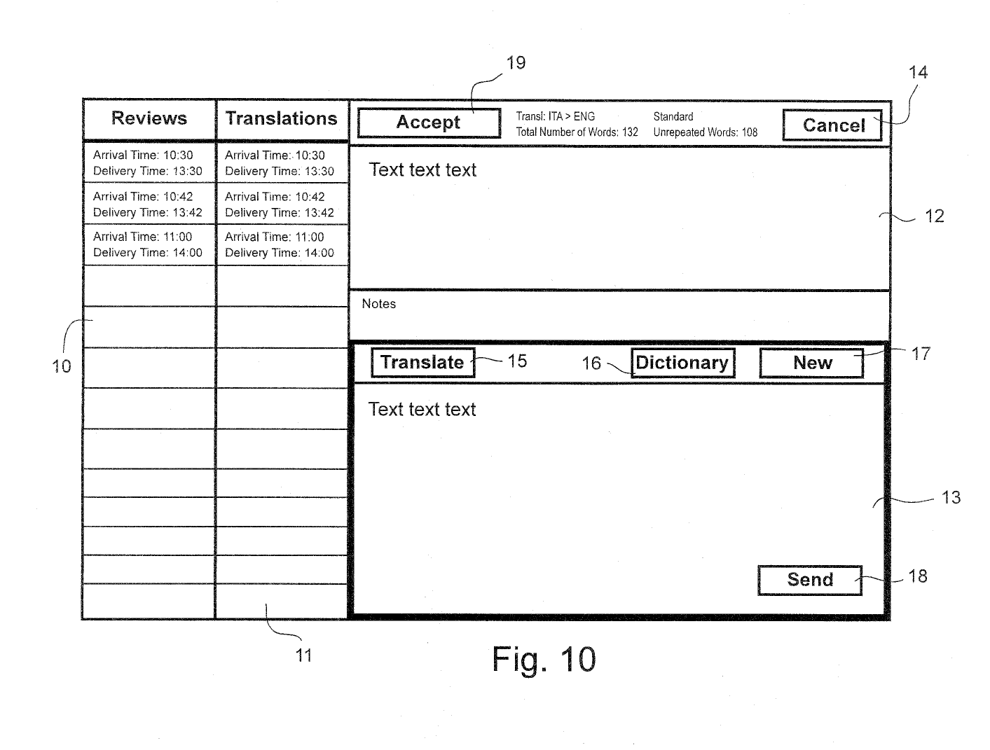

As shown in FIG. 10, the GUI for the translation processing available to the senior translator is different from the one GUI described above. In this case the GUI comprises a first area 10 showing the list of translations to be reviewed coming from the junior translators, a second area 11 showing the list of translation requests assigned to him by the server component, a third area 12 showing the source text of the currently selected request, and a fourth area 13 for editing the translated text.

By selecting one of the entries of the list appearing in the first area 10, the source text and the related translation provided by a junior translator are shown in the third 12 and fourth area 13 respectively. The fourth area 13 allows the translated text to be edited in order for the senior translator to correct it.

The second area 11 contains a list of the translation requests which the server component has assigned to the senior translator. By selecting one of the entries of the list appearing in the second area 10, the source text of the respective translation request is shown in the third area 12.

The senior translator can refuse the translation request by clicking on the Cancel button 14 and choosing one of the following options offered by the system: “insulting matter” or “text too much demanding” or “incomprehensible text”.

The fourth area 13 for the processing of the translation is editable only if the translator accepts the translation request by clicking the Accept button 19. In this area there are four buttons, Translate button 15, Dictionary button 16, New button 17, Send Button 18. By clicking on the Translate button 15 the best automatic translation provided by the translation engine (described above) appears in the third area 12 and it can be edited by the translator. If the senior translator is checking a translation provided by a junior translator the Translate button 15 is disabled.

The Dictionary button 16 allows the translator to visualize a list of words belonging to the field of the text and their corresponding translation. By clicking on the New button 17 the translator can add to the above cited list one word.

Finally, the Send button 18 allows the translator to complete the translation and to send it to the server component which stores it on the workstation and makes it available to the user client component.

If the senior translator is reviewing a translation provided by a junior translator, a dialog window opens up. In this window the senior translator can insert the evaluation of the junior translator and a comment on the evaluation that is mandatory in the case of a negative evaluation. These comments can be seen only by the system administrator. In the same dialog window, it is also possible to write down a note for the user which requested the translation.

While one preferred embodiment has been described, variations and modifications can be made as will occur to those skilled in the art. The invention is not limited to the preferred embodiment, and the scope of the invention is defined by way of the following claims.

1. A system for translating text from a source language to a target language comprising:
a computer system having an operation program for receiving a translation request from a user and for implementing a translation, said computer being connected to the internet, said program obtaining at least two complete translations of a source language to a target language using at least two different respective machine translation programs, said operation program rating the accuracy of each complete translations by searching for a string of words of the target language translation in an internet search engine for each translation program, and selecting as the final automatic machine translation the complete translation from the translation program having the highest number of matches from the search engine for the word string.

2. The system according to claim 1, wherein the operation program obtains complete translations using automatic machine translations on a pre-selected list of automatic machine translations.

3. The system according to claim 1, wherein the string of words is a string of consecutive words.

4. The system according to claim 3, wherein the string of words is a string of consecutive strings of words starting with the first word in the same language text.

5. The system according to claim 1, wherein the operation program rates the translation programs by searching for a plurality of strings of words of increasing length.

6. The system according to claim 1, wherein the operation program provides the final automatic machine translation to a selected human translator for review according to selection criteria.

7. The system according to claim 6, wherein the selection criteria includes knowledge of the source and target languages, and the subject matter field of the text of the human translators.

8. The system according to claim 6, wherein the selection criteria includes rating information for each human translator.

9. The system according to claim 6, wherein the selection criteria includes human-time needed for a human translator to review and execute further translation processing.

10. The system according to claim 6, wherein the operation program controls storage of information for human translators in a first group of senior translators, and a second group of junior translators.

11. The system according to claim 10, wherein the operation program controls storage of information rating the junior translators based on reviews by senior translators.

12. The system according to claim 1, wherein the operation program controls storage of information of a user's account.

13. The system according to claim 1, wherein the computer system comprises a user personal computer (PC) and a server computer.

14. The system according to claim 1, wherein the operation program provides a user with selection of a first quick translation mode of a certain number of words within a first time period, and a second, longer translation mode of a greater number of words within a longer time period.

15. The system according to claim 1, wherein the operation program controls storage of translations in an archive.

16. An article of manufacture comprising:
a computer usable medium having computer readable program code embodied therein for causing a translation of text from a source language to a target language, the computer readable program code in said article of manufacture comprising:
computer readable program code for receiving a translation request from a user and for implementing a translation, said program obtaining at least two complete translations of a source language to a target language using at least two different respective machine translation programs, said program code obtaining a rating of the accuracy of each complete translation by searching for a string of words of the target language translation in an internet search engine for each translation program, and selecting as the final automatic machine translation the complete translation from the translation program having the highest number of matches from the search engine for the word string.

17. The article according to claim 1, wherein the program code obtains complete translations using automatic machine translations on a pre-selected list of automatic machine translators.

18. The article according to claim 16, wherein the strings of words are consecutive strings of words.

19. The article according to claim 16, wherein the strings of words are consecutive strings of words starting with the first word.

20. The article according to claim 16, wherein the program recites the translation programs by searching for a plurality of strings of words of increasing length.

21. The article according to claim 16, wherein the program provides the final automatic machine translation to a selected human translator for review according to selection criteria.

22. The article according to claim 20, wherein the selection criteria includes knowledge of the source and target languages, and the subject matter field of the text of the human translators.

23. The article according to claim 20, wherein the selection criteria includes rating information for each human translator.

24. The article according to claim 16, wherein the selection criteria includes human-time needed for a human translator to review and execute farther translation processing.

25. The article according to claim 21, wherein the selection criteria includes information on the workload of each human translator.

26. The article according to claim 21, wherein the operation program controls storage of information for human translators in a first group of senior translators, and a second group of junior translators.

27. The article according to claim 26, wherein the program controls storage of information rating the junior translators based on reviews by senior translators.

28. The article according to claim 16, wherein the program controls storage of information of a user's account.

29. The article according to claim 16, wherein the program provides a user with selection of a first quick translation mode of a certain number of words within a first time period, and a second, longer translation mode of a greater number of words within a longer time period.

30. The article according to claim 16, wherein the program controls storage of translations in an archive.

31. A method for translating text from source language to a target language, comprising:
receiving a translation request from a user and for implementing a translation;
obtaining at least two complete translations of a source language to a target language using at least two different respective machine translation programs;
rating the accuracy of each complete translation by searching for a string of words of the target language translation in an internet search engine for each translation program; and
selecting as the final automatic machine translation, the complete translation from the translation program having the highest number of matches from the search engine for the word string.

32. The method according to claim 31, comprising obtaining complete translations using automatic machine translations on a pre-selected list of automatic machine translations.

33. The method according to claim 31, wherein the strings of words are consecutive strings of words.

34. The method according to claim 31, wherein the strings of words are consecutive strings of words starting with the first word.

35. The method according to claim 31, wherein the step of rating comprises rating the translation programs by searching for a plurality of strings of words of increasing length/

36. The method according to claim 31, further comprising providing the final automatic machine translation to a selected human translator for review according to selection criteria.

37. The method according to claim 36, wherein the selection criteria includes knowledge of the source and target languages, and the subject matter field of the text of the human translations.

38. The system according to claim 36, wherein the selection criteria includes rating information for each human translator.

39. The method according to claim 36, wherein the selection criteria includes human-time needed for a human translator to review and execute further translation processing.

40. The method according to claim 36, wherein the selection criteria includes information on the workload of each human translator.

41. The method according to claim 31, wherein the operation program controls storage of information rating the junior translators based on reviews by senior translators.

42. The method according to claim 31, comprising controlling storage of information of a user's account.

43. The method according to claim 31, comprising using a personal computer (PC) and a server computer.

44. The method according to claim 31, comprising providing a user with selection of a first quick translation mode of a certain number of words within a first time period, and a second, longer translation mode of a greater number of words within a longer time period.

45. The method according to claim 31, comprising controlling storage of translations in an archive.

46. A system for translating text from a source language to a target language comprising:
a user client program component running over a local PC of a user, from which a translation request is sent;
a server program component running over a server workstation; and
a translator client program running over a local PC of a translator, from which a translation request is processed.
